(19) United States
(12) Patent Application Publication
(10) Pub. No.: US 2013/0346339 A1
(43) Pub. Date: Dec. 26, 2013

(54) CONFIGURING PROCESS VARIANTS FOR ON-BOARDING CUSTOMERS FOR INFORMATION TECHNOLOGY (IT) OUTSOURCING

(71) Applicants: Wen Yao, State College, PA (US); Sujoy Basu, Sunnyvale, CA (US); Jun Li, Mountain View, CA (US); Bryan Stephenson, Alviso, CA (US); Sharad Singhai, Belmont, CA (US)

(72) Inventors: Wen Yao, State College, PA (US); Sujoy Basu, Sunnyvale, CA (US); Jun Li, Mountain View, CA (US); Bryan Stephenson, Alviso, CA (US); Sharad Singhai, Belmont, CA (US)

(21) Appl. No.: 13/531,198

(22) Filed: Jun. 22, 2012

(51) Int. Cl. G06Q 10/06

(52) U.S. Cl. 705/348

(57) ABSTRACT

Systems and methods of configuring process variants for on-boarding customers for information technology (IT) outsourcing are provided. An example method includes modeling roles, responsibilities, and business context for a standard process template. The method also includes developing cause-and-effect rules affecting outcome of the standard process template. The method also includes adjusting the standard process template for process variants across different customer on-boarding scenarios.

### BACKGROUND

Outsourcing Information Technology (IT) enables businesses to improve competitiveness by focusing on their core competencies, instead of having to manage IT services. IT service providers offer customers standardized services by combining best practices with specialized technical offerings and expertise across different industry verticals. These standardized services can be repeated for different customers, and thus help ensure that the services are delivered cost-effectively and at a high quality.

Standardized services seek to address the vast majority of customer requirements, and custom processes are only used when these will have a significant impact on the customer's business. Even when custom processes are used, standard processes and technology components are still used to the extent possible, and are adapted to meet specific customer requirements. These “one-size-fits-all” and “semi-custom” approaches for delivering IT services are inefficient, may reduce overall customer satisfaction, and can be costly to deploy.

### BRIEF DESCRIPTION OF THE DRAWINGS

FIG. 1 is a diagram illustrating an example methodology of configuring process variants for on-boarding customers for information technology (IT) outsourcing.

FIG. 2 is a system diagram illustrating an example architecture used to configure process variants for on-boarding IT outsourcing.

FIG. 3 shows a partial representation of an example semantic business process ontology (SBPO) for modeling the on-boarding process.

FIG. 4 shows a partial representation of an example composite process IT Asset Management (ITAM) delivery model, including atomic and composite processes.

FIG. 5 shows a partial representation of an example on-boarding context model (ONBRD) for customer on-boarding.

FIG. 6 shows example categories of rules and corresponding semantic space.

FIG. 7 is a flowchart illustrating an algorithm for configuring process variants.

FIG. 8 is a flowchart illustrating example operations which may be implemented for configuring process variants for on-boarding IT outsourcing.

### DETAILED DESCRIPTION

A consistent theme in information technology (IT) outsourcing is moving the customer's IT environment to the service provider's mode of operation, which is known in the IT services industry as “on-boarding.” On-boarding entails many aspects of transition and transformation, from when a customer first contracts with the IT service provider through actual delivery of IT services on a “steady-state” basis (e.g., a consistent and ongoing basis). Transition is the process for the provider to assume operational responsibility for a customer's IT environment. Transformation is the implementation of contractually defined activities that enable the service provider to provide service enhancements, cost reductions, and quality, productivity, and technology improvements.

To improve repeatability and enforce adoption of best practices, a standard set of processes may be established by the IT service provider to direct, control, and measure on-boarding activities for each customer. This process is complex and may be adapted across different customers according to varying implementation environments and customer parameters. It is difficult to incorporate process variants needed for these diverse scenarios into a single on-boarding process model, so that these processes can be reused.

Various approaches to consolidate knowledge which define generally accepted rules and processes have been used in the form of plain text documents. An on-boarding practitioner needs to manually look up various parameters, and then apply the so-called “best practice” to a given scenario. However, process variations are typically not addressed by these approaches. Other studies have contributed towards the configuration of process variants, but they often assume a predefined base or template process model with hundreds or thousands of configuration points. In addition, these studies do not work well for large and/or complex base processes.

The approach described herein addresses on-boarding for diverse customer scenarios based on ontology and rules to model the standard on-boarding process, and then configure process variants based on the business context that characterizes various scenarios. The approach may also utilize semantic rules to model adaptation policies and dynamically generate a customized process variant schema (e.g., “on the fly”). The developed framework can be used to support a flexible process variant configuration, increase overall customer satisfaction, while reducing implementation costs.

An ontology-based approach to model the on-boarding process, as described herein, can be readily applied to large, complex, hierarchical, and human centered environments. The approach facilitates a shared understanding among the different entities involved in the on-boarding process, and provides a common vocabulary for users and software agents. The approach identifies adaptations which may be needed for a specific customer context.

Adaptations may be dynamically introduced into the standard process using semantic rules. These adaptations allow IT service providers to design flexible, yet constrained process variants, based on customer parameters. The resulting variant is an ontological process model that can be further converted into executable process such as BPEL models for process tracking and monitoring.

In addition, the systems and methods described herein may be used to facilitate search and management of process variants in a large repository. Each process variant is contextual, and thus a small set of desired variants may be retrieved using context variables according to the user query. The deployment phase also allows the systems and methods to be used by both the on-boarding team and global process owners.

Before continuing, it is noted that as used herein, the terms “includes” and “including” mean, but is not limited to, “includes” or “including” and “includes at least” or “including at least.” The term “based on” means “based on” and “based at least in part on.”

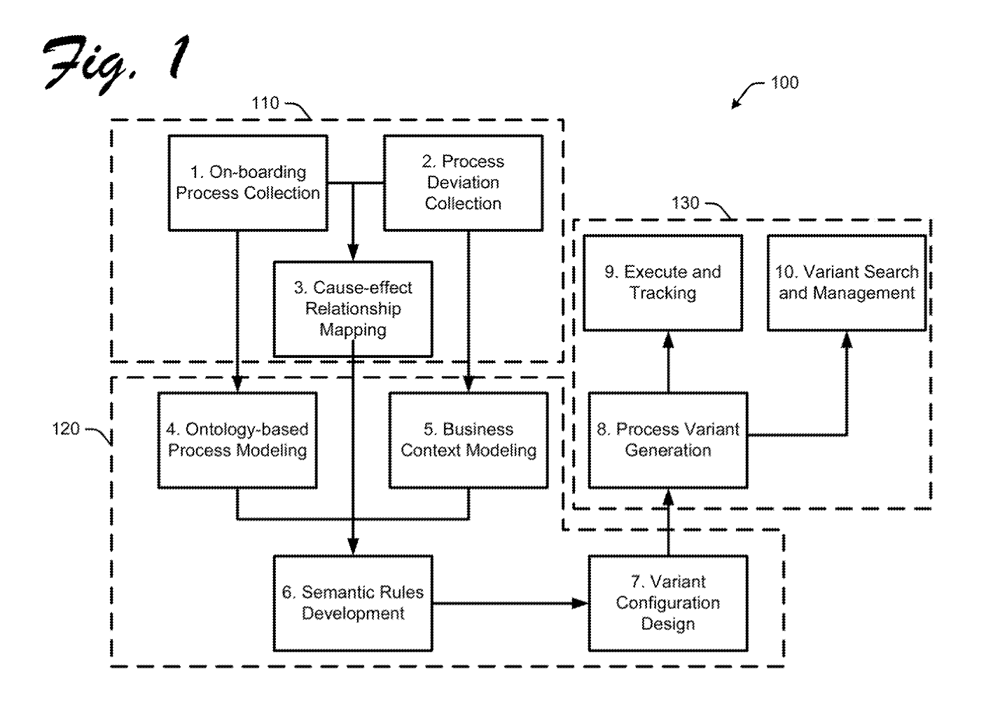

FIG. 1 is a diagram 100 illustrating an example methodology of configuring process variants for on-boarding information customers for technology (IT) outsourcing. The design methodology is illustrated as having three phases 110-130. It is noted that the phases are shown for purposes of illustration, may be iterative, and the steps within the phases do not need to be performed in the order shown.

In an example, a data collection phase 110 (including steps 1-3), or solution design phase, defines the scope of service delivery and a contract may be signed. The data collection phase 110 may include input from case studies in on-boarding projects and interviews with on-boarding managers and team members. In an example, process guides based on best practices stated in the Information Technology Infrastructure Library (ITIL) and collected process logs of past projects were used (steps 1-2). Deviations in these process logs may be analyzed with the help of domain experts to link these with individual steps in the standard process guides and associate these deviations with their causes (step 3).

A modeling phase 120 (steps 4-7), transforms collected data into a formalized framework. Process designers and knowledge engineers may be involved in this phase. A system may be implemented based on the modeling phase.

A deployment phase 130 (including steps 8-10) utilizes output from the first two phases to on-board the customer. On-boarding may be accomplished by following the process variant generated in step 8.

The on-boarding conducted in step 9 of the deployment phase 130 gives customers a first impression of the IT service provider's capabilities, and data collected during this phase may be used in step 10 of the phase 130 as well as in step 2 of the modeling phase 120. Handling of the on-boarding phase 110 may influence chances of the customer buying additional services from the same provider. The entire on-boarding phase may be managed by the IT service provider, as a standard process, similar to the many processes that the IT service provider follows during a steady-state operations phase. The standard process may need to be adapted based at least in part on varying parameters for different customers, industry verticals, geographic regions, and scale of IT operations, to name only a few examples.

The following three example scenarios illustrate variations which may be encountered during on-boarding.

(A) Customer A requests tracking maintenance contracts and lease agreements on IT assets. As a result, the IT service provider will need to notify customer A about additional client-specific data attributes. Then, required data attributes may be collected manually and/or automatically and loaded into the data repository.

(B) Customer B is a large organization located in a non-English speaking country with more than ten service providers. As a result, the primary service provider requests to setup a translation service and a service exchange that enables bi-directional routing of service cases among the providers.

(C) Customer C pays a premium for expediting the on-boarding process. Thus, the service provider needs to assign extra human resources and parallelize tasks where possible.

Because variations can occur in practice, it is challenging to document, track, and reuse the process variants that deviate from the standard process. Further challenges may include the size, hierarchy, and human-involvement of a standard on-boarding process. In practice, variations can also occur in different sub-processes of the on-boarding process. These changes often need to be reviewed by the process owner for every new context. However, this review process takes time because input may be requested from other people involved in this and related sub-processes. Thus, it can be difficult to integrate a large number of variations together in the standard on-boarding process.

Another challenge is in mapping context of the outsourcing projects to the available sub-processes and possible adaptations. This typically involves manual work to understand context of the project and identifying adaptations of the standard process. There may also be a need for manual configuration of the parameters for every identified process variant. The manual configuration may have to be repeated if the process variant occurs in another outsourcing deal. In order to reduce the steps involved in tedious manual configuration, a formal framework may be used to capture cause-effect relationships between the business context and variations in the standard on-boarding process.

Another challenge is when variations in past cases are managed in an ad hoc manner. After an on-boarding process is completed, a significant amount of data related to the process variations may remain in text fields in project management databases, emails, and other text documents exchanged among members of the on-boarding team. An efficient mechanism may be used to compare the variations from a standard process in a large repository including these documents. Otherwise, continual improvement of the on-boarding process can become burdensome.

These and other challenges are handled by the systems and methods described herein by using a governance framework that can manage complex outsourcing deals. A process variant modeling framework is utilized to capture a standard on-boarding process and the associated business context in a common knowledge-base, and rules are used to dynamically configure a process variant tailored for the business context of a specific customer.

An example approach implemented by the systems and methods described herein uses semantic web technologies to model and configure process variants, to: formalize on-boarding related process, knowledge, and its business context in a common, actionable framework; allow configuration of process variants tailored for the business context of a specific customer; and facilitate search and management of desired process variants within a large repository.

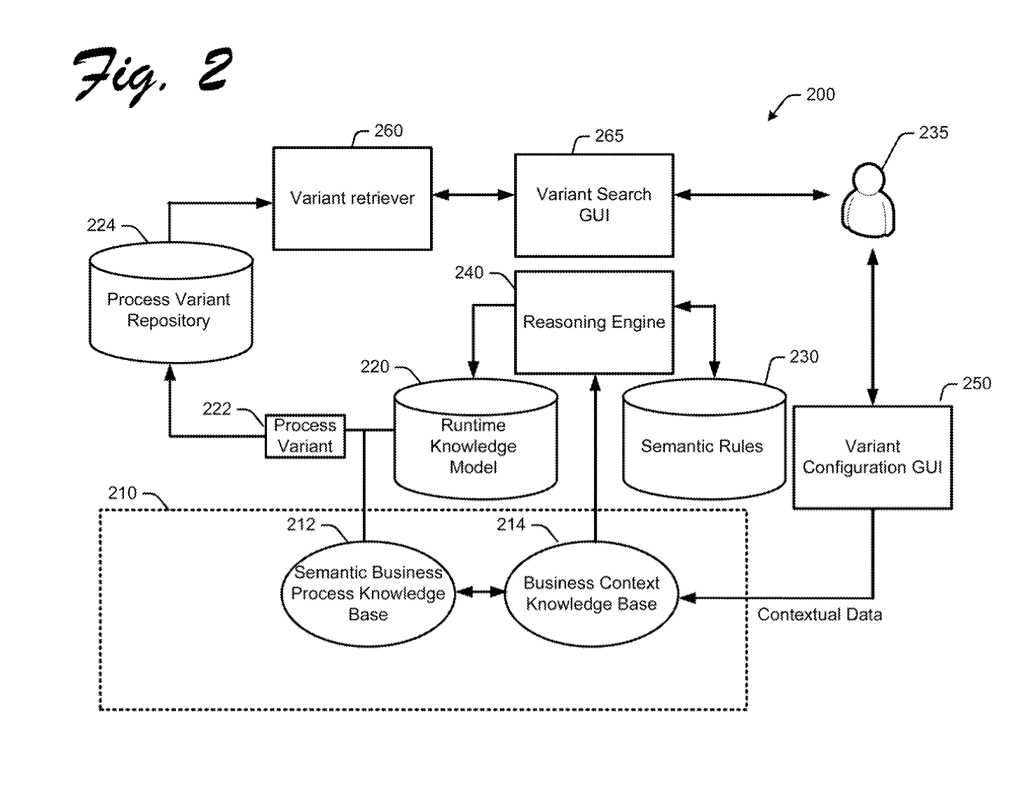

FIG. 2 is a system diagram illustrating an example architecture 200 used to configure process variants for on-boarding IT outsourcing. The example architecture may be embodied as program code or machine readable instructions, which may be executed in a suitable processor environment. For example, the machine-readable instructions may be stored on a non-transient computer readable medium and are executable by one or more processor to perform the operations described herein. The program code may execute the function of the architecture of machine readable instructions as self-contained modules. These modules can be integrated within a self-standing tool, or may be implemented as agents that run on top of an existing program code. It is noted, however, that this computing environment is provided only for purposes of illustration, and is not intended to limit implementation to any particular system.

The architecture 200 may include ontological knowledge framework 210, including a Semantic Business Process Model (SBPO) 212, and a business context knowledge database 214. The SBPO 212 captures concepts and relationships in a body of knowledge for customer ON-BoaRDing (ONBRD). A runtime knowledge model 220 is a working memory that maintains the runtime knowledge (e.g., data related to a specific variant, instance). The output is a process variant to be stored in a process variant repository 224. Semantic rules 230 may be developed to model cause-and-effect relationships, and to generate process variants. In an example, an end user 235 (e.g., the on-boarding manager) can create process variants dynamically or “on-the-fly,” use these process variants to track the on-boarding process in practice, and retrieve the desired variants from a repository.

It is noted that “ontology” as a term used herein, is a formal representation of knowledge as a set of concepts within a domain, and the relationships among these concepts. The ontology can facilitate knowledge sharing, logical inference, and knowledge reuse. In an example, the system encodes two ontologies so that these can be shared across various people, organizations and software agents.

The ontology approach may be implemented as part of a semantic process management model that allows automatic customization of the customer on-boarding process. Unlike other semantic process models which support a core set of constructs to define Web services, the model described herein supports high level business objectives, organizational responsibilities and human tasks, recognizing that many tasks are human oriented and cannot be automated by Web services. It also enables low-level workflow configuration triggered by the customer context. This approach can be readily implemented by non-technical users for variant configuration and management.

The architecture 200 may employ a formal design methodology to develop a semantic process management model that allows automatic customization of the customer on-boarding process. Unlike other semantic process models, which may support a core set of constructs to define Web services, the model emphasizes high-level business objectives and organizational responsibilities, recognizing that many tasks are human oriented and cannot be automated by Web services. It also enables low-level workflow configuration triggered by the customer context. This approach can be easily used by non-technical people for variant configuration and management.

An example architecture 200 may utilize the ontological knowledge framework 210, for example, implemented using an open source ontology editor such as Protégé 3.4, to encode the two ontologies (SBPO 212 and ONBRD 214), using the Web Ontology Language (OWL).

A reasoning engine 240 includes execution of the semantic rules 230 and performs reasoning using rules and data as input. New data that is inferred may also be added to the set of existing data, which may in turn trigger application of additional rules (referred to herein as “forward chaining”).

A variant configurator GUI 250 is the user interface that helps users to generate customized on-boarding process variants dynamically or “on the fly.” The variant configurator 250 acquires case data from an end user and feeds it to the context knowledge base, so that semantic rules can be triggered to produce a variant automatically. The variant configurator 250 may also extract context variables from the business context knowledge base ONBRD 214, and present these to the end user 235 in a user friendly format. Thus, the end user 235 can select a value, and assign that value to a context variable. After a variant is generated, the variant may be presented to the end user 235 in a graphical model.

A variant retriever 260 searches process variants in the repository with a given query from the end user. Because all the process variants may be configured with the rule-based approach and stored in the repository, these variants can be retrieved using the context variables via a variant search graphical user interface 265.

The first ontology is SBPO. SBPO addresses the challenges of modeling the on-boarding process, which can be large, complex, and mostly executed by people (not automated by computers). The second ontology is ONBRD. ONBRD satisfies the need for a domain-specific model for the business context of on-boarding. With first-order logic, the models and description of data in these models can be formally validated.

Ontology-enabled semantic process modeling provides a unified view on the process space of an organization in a machine-readable form. It facilitates process modeling down to the operations level from the business perspective. The execution of these operations may be accomplished on IT systems, and/or manually (depending on the type of task). Thus, this model is suitable for use in a collaborative and complex environment where people from different functional units may be involved.

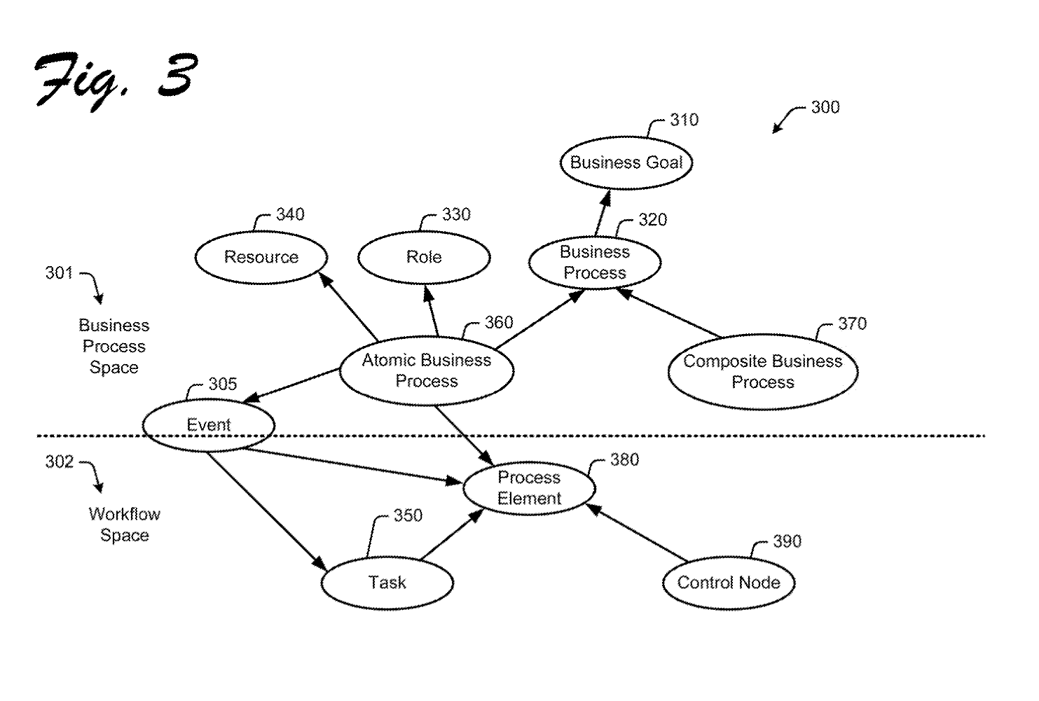

FIG. 3 shows a partial representation of an example semantic business process ontology (SBPO) for modeling the on-boarding process. The model supports, in terms of domain concepts, Business Goals 310, Business Processes 320, Roles 330, and Resources 340, to name only a few examples, in addition to the corresponding semantic relationships. These concepts may be divided into two levels concerning the business and the technical perspectives of a process respectively. Business perspective 301 refers to high-level concepts that are typically in the domain of, and can be understood by business people. A business process 320 can be atomic or composite. In an example, an atomic business process 360 is executable and triggered by event 305. The atomic business process 360 may include process elements 380 such as tasks 350 or control nodes 390. A task 350 defines work performed by a role, and can be performed by a machine or a human. The task 350 cannot be broken down to a finer level of process model details. Tasks 350 are connected by control nodes 390 that define the way tasks can be executed, including for example, in parallel, as an exclusive choice, in a loop, and other execution types. A composite business process 370 is compound and it can be further composed of other atomic or composite processes.

A business process space 301 deals with high level activities and the compositions, roles and responsibilities, business goals. A workflow space 302 handles low level execution of tasks 350 and coordination. For example, a workflow model specifies whether a task is executed by Web services or human beings, and whether two tasks are executed in parallel or in sequence. Note that the on-boarding process is constrained in some way by the capability of ontology modeling, but it is still flexible because no strictly defined control flow relationship is enforced among tasks. All the processes and entities from the on-boarding process are captured in the ontological database.

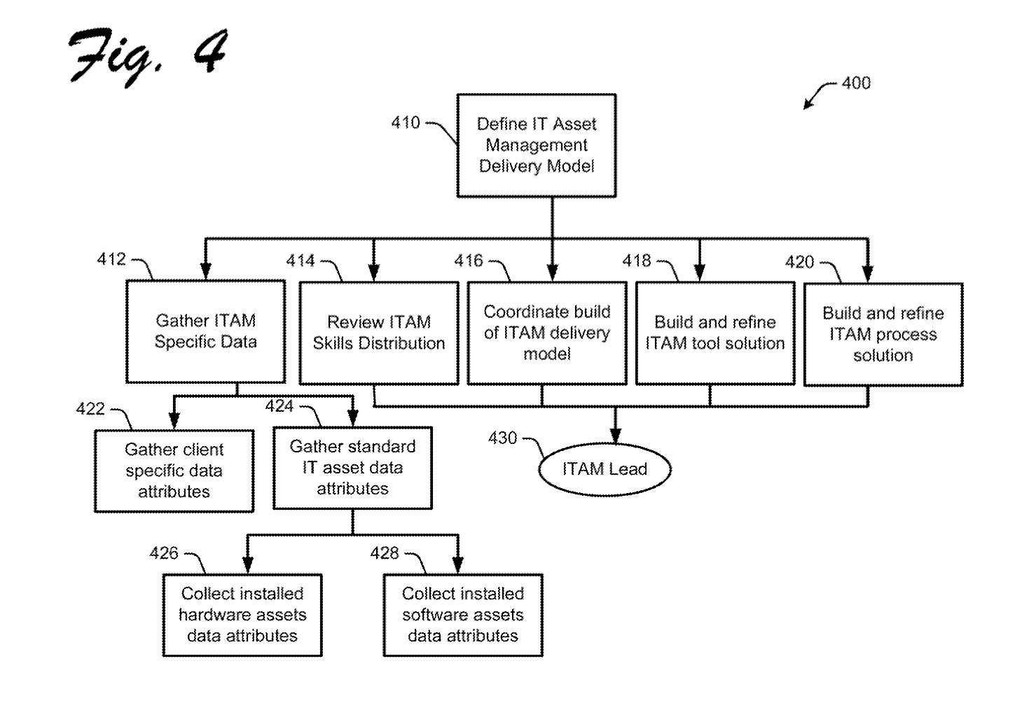

FIG. 4 shows a partial representation of an example composite process 400 that defines an IT Asset Management (ITAM) delivery model, including atomic and composite processes. The modeling framework further captures the business context that causes variations during customer on-boarding. Context is any information used to characterize an entity. With respect to the IT outsourcing environment, context is defined as elements of the business environment that can cause variations in a standard process template.

In FIG. 4, the composite process 400 of defining the IT Asset Management delivery model starts with the composition 410 of several processes at the next level, namely 412, 414, 416, 418 and 420. Of these, level 412 is a composite process of gathering data on all IT assets. The other processes 414, 416, 418, and 420 are atomic.

Atomic process 414 is a review of skills pertaining to asset management available within the IT service provider's organization that may be deployed without impacting the delivery of other projects. Atomic process 416 is a planning task where the schedule is defined for deploying people available with the IT service provider's organization, along with the schedule for deploying software tools and processes. Atomic process 418 is the work needed to customize the software tools, to interface correctly with the specific IT environment of the client. Atomic process 420 is the work needed to customize the processes, so that they are optimized to the specific IT environment of the client.

The composite process 412 includes atomic process 422 and 424. Atomic process 422 is the work needed to collect attributes that are specific to the client's contract and IT environment. An example is extraction of attributes on software licenses from purchase orders, where the attributes are type of support from vendor and expiration date of the license. This work may be performed when the contract stipulates that the service provider is to track licenses for the client.

The atomic process 424 is work for collecting standard attributes of IT assets, such as the IP address and physical location of all printers to be managed. The work done by atomic process 424 can be considered as two sub-tasks 426 and 428, which specify the work be done for hardware and software assets, respectively. This is an opportunity to introduce parallelism within the process.

IT Asset Management Lead 430 is a role within the service provider's organization. Processes 414, 416, 418 and 420 are shown in FIG. 4 as these may be performed by a person in this role.

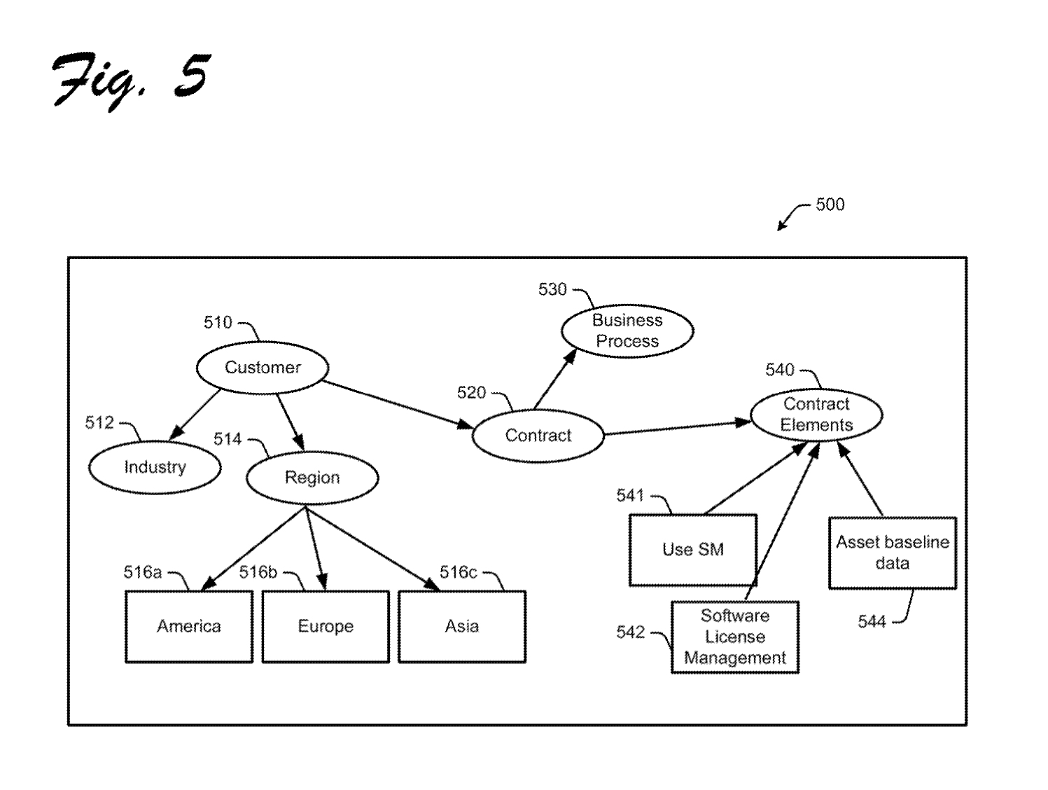

FIG. 5 shows a partial representation of an example on-boarding context model (ONBRD) 500 for customer on-boarding. The model captures diverse factors, such as industry vertical, geography, size of outsourcing deal, and various contract elements (e.g., inclusion of software license management), to name only a few examples. These factors can have significant influence on the process for on-boarding customers to IT outsourcing. For each new case or outsourcing deal, the contextual data may be captured as assertions or instances in the knowledge base. This can trigger changes to be applied on the standard process template (e.g., through semantic rules). As a result, a customized process variant that is tailored to customer needs can be dynamically generated.

ONBRD model 500 shown in FIG. 5 captures the business context that can impact customer on-boarding. A customer 510 is characterized by its industry type 512, region 514, and the signed contract 520. Region 514 describes the customer location (e.g., America 516a, Europe 516b, Asia 516c). A customer 510 signs a contract 520 that includes various contract elements 540, such as the use of service manager 541, software license management 542, and providing asset baseline data 544, to name only a few examples. A contract has many attributes, such as goal, deal size, discount, status, etc. Each contract is managed by a business process 530 (or a customer on-boarding process). Thus, different contracts along with various customer characteristics, will lead to various on-boarding processes in practice.

In addition, the on-boarding business context model can be maintained and updated by knowledge engineers as more context variables are identified and captured in practice. This helps ensure the output process variants are semantically correct.

During operation, ontological knowledge framework captures the knowledge of the standard on-boarding process in terms of important concepts and their semantic dependencies. Contextual variables are also captured.

Semantic rules may be represented as “If-Then” statements and then rewritten as rules for formal encoding. Thus, these can be used to capture the cause-effect relationship between the business context and variations in the on-boarding process. The rules may be developed in consultation with domain professionals from the on-boarding teams, and first expressed in a natural language before being rewritten in a formal language for encoding semantic rules.

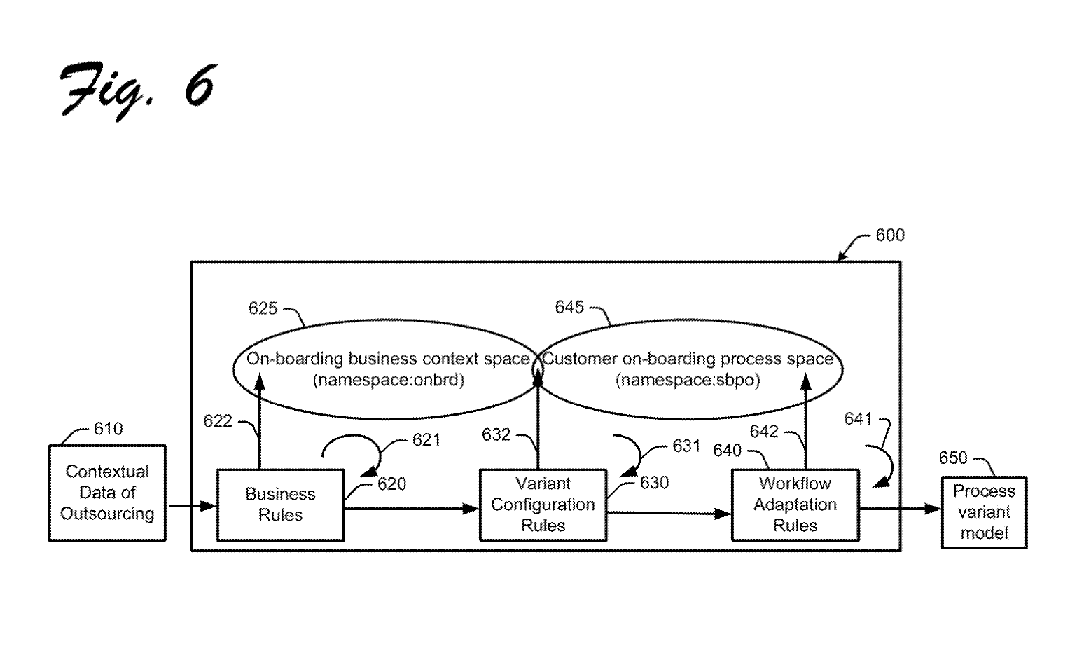

The semantic rules address the two semantic spaces and their intersection. The rules may be categorized as business rules, variant configuration rules, and workflow adaptation rules. FIG. 6 shows example categories of rules and corresponding semantic space. Triggering rules can add inferred information to the captured business context that in turn triggers other rules, based on forward chaining.

FIG. 6 is a diagram 600 illustrating three categories of semantic rules which may be implemented for process variant configuration. Business rules 620 address 622 the on-boarding business context space 625 and formalize business policies within the space 625. Business rules can be triggered 621 by the contextual data of outsourcing 610 (e.g., industry type, contract details) that characterize an outsourcing deal. When business rules are executed or “fired,” these fired business rules may produce new data that can further trigger 631 variant configuration rules 630. In turn, fired variant configuration rules 630 may produce change operations to be applied on the standard process template.

Variant configuration rules 630 address 632 the intersection of on-boarding business context space 625 and customer on-boarding process space 645. After a standard process template is modified, workflow adaptation rules 640 (that can enable self-adaptation of workflow models within the on-boarding process space 645) may be triggered 641 and produce a process variant model 650. Workflow adaptation rules 640 address 642 only the customer on-boarding process space 645.

Business Rules (BR) formalize business policies and address the business context space of customer on-boarding (ONBRD). For example, organizations may have different policies to determine deal size and discount rates for different deals. Rule BR_{—}1 below is an example rule for an organization where the deal is defined to be large if the deal amount is larger than 50 million:

BR_{—}1: (?contract onbrd:hasDealAmount ?amount), greaterThan (?amount, 50,000,000)→(?contract, onbrd:hasDealSize “large”)

Variant Configuration Rules (VCRs) may be triggered by the business context space (ONBRD), produce change operations, and apply these operations on the standard process template from the on-boarding process space (SBPO). Hence, VCRs address the intersection of the two semantic spaces. The change operations or adaptation patterns cover the following five different perspectives of a business process model, including for example, organizational, functional, behavioral, data, and business goal.

Organizational perspective involves roles and responsibilities in the process. Functional perspective captures what activities are performed. Behavioral perspective describes the execution sequence of activities. Data perspective records the data flow among activities. Business goals, KPIs, and metrics are available in the goal perspective. For example, the following rule VCR_{—}1 shows an additional role for subject-matter expertise (ProcessSME) is needed to be responsible for a certain process when dealing with large deals. Rules that reflect other perspectives are formalized in a similar way.

VCR_{—}1: (?contract onbrd:hasDealSize “large”), (?contract, onbrd:handledBy ?bp), (?bp is ComposedOf ?bp2), (?bp2 sbpo:hasOutput sbpo:IT_process_transformation_solution)→(?bp2 hasResponsibleRole sbpo:ProcessSME)

Workflow Adaptation Rules (WARs) enable self-adaptation of a workflow model, and address the on-boarding process space (SBPO). WARs may be used because data inconsistencies and wrong task execution order can be the outcome after adaptation rules from BR and VAR have been applied. The adaptation rules from WAR perform consistency checks to ensure that the control-flow and data dependencies are satisfied, and restore structural correctness to the resulting process variant. For example, if a task t1 is removed by variant configuration rules, all the tasks dependent on task t1 should also be removed.

Rule WAR_{—}1, below, indicates that the second triple in the condition part, for example (?t2 sbpo:belongsTo ?bp), is removed. Accordingly, the relationship between task t2 and business process by are removed, because t2 is dependent on removed task t1.

WAR_{—}1: (?t2 sbpo:dependentOn ?t1), (?t2 sbpo:belongsTo ?bp), noValue (?t1 sbpo:belongsTo ?bp)→remove (1)

The above three categories of adaptation rules illustrate how business policies, process adaptation policies, and workflow adaptation strategies can be separated. These rules in each part may be managed by a person with the corresponding perspective. For example, when business policies change, only the impacted business rules have to be updated. Variant configuration rules will be updated only when the policy for IT operations based on business parameters changes.

These rules may be implemented using the following example algorithm to characterize an outsourcing deal and generate a process variant schema that is tailored to customer needs.

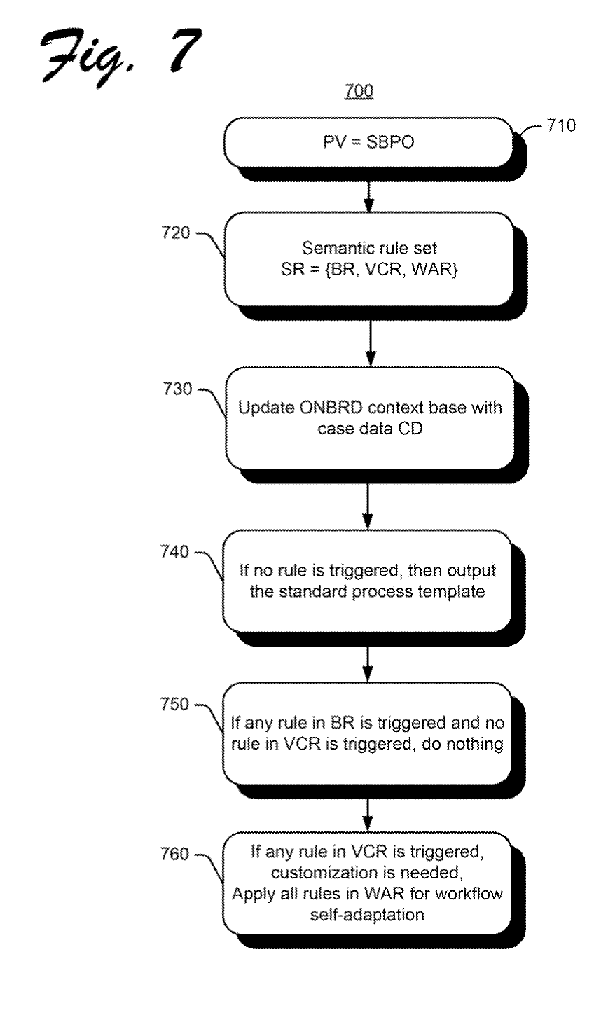

FIG. 7 is a flowchart illustrating an algorithm for configuring process variants. In operation 710, the default variant is set as the process template (PV=SBPO). In operation 720, the semantic rule set is used, SR={BR, VCR, WAR}, where BR denotes business rules, VCR denotes configuration rules, WAR denotes workflow adaptation rules. In operation 730, the ONBRD context base is updated with case data CD. In operation 740, if no rule in BR is triggered, then the system outputs the standard process template. In operation 750, if any rule in BR is triggered and no rule in VCR is triggered, then nothing new is executed. In operation 760, if any rule in VCR is triggered, then customization is needed, and all rules in WAR are applied for workflow self-adaptation. This leads to self-adaptation, and the process variant (PV) is output.

In the above algorithm, if no business rule or variant configuration rule is triggered (e.g., no customization required for this case), then the output variant is the process template, because no change is applied. If any variant configuration rule is triggered, it may trigger workflow adaptation rules as well for self-adaptation. The resulting workflow model with adaptations is the ultimate process variant, and can be further transformed into a BPEL process.

In an illustration, David is an on-boarding manager and he is responsible for on-boarding customer ABC Company to IT outsourcing. ABC Company is a large corporation in the telecom industry, and is located in Europe. The deal amount is $120M and the contract includes parameters, such as “need to track maintenance contract”.

David is provided with a number of questions that are derived from the context model, and he is guided with choices to provide the customer data. Because the standard processes are formalized in the ontological knowledge base, and the variations are captured by semantic rules, the algorithm discussed above allows automatic configuration of the on-boarding process.

Output may be displayed in a graphical user interface. Graphical user interfaces are known and therefore are not shown here. An example of the graphical user interface may output a first panel displaying high level activities (or processes) and their compositions in a hierarchical structure. Another panel may show the user different perspectives of the selected process, including roles and responsibilities, data, resources, etc. The user can click tabs in the panels to learn the details of their selections. Another panel may depict the workflow model graphically for a selected process. Required tasks and coordination can be readily understood from the graph. The variant is loaded from an ontology model that captures various aspects of a business process. The output can be further transformed into a standard BPEL process.

In another example, process owners may want to search for desired process variants in the repository. As the repository becomes very large (e.g., with hundreds of thousands of process variants), searching based on structural similarity often returns a large result set. In addition, many of the retrieved variants may be irrelevant to the user's business context. The approach described herein addresses this issue by replacing the search by configuring each variant based on the context model.

Again, a graphical user interface may be used. The graphical user interface may display all past process variants for on-boarding projects for a medium deal size, where the customer is located, and the customer's industry. The query is derived by reading the values of the three context variables provided by the user. By supporting queries on context variables, the search can return a small set of desired variants. Selectivity of the query can be increased by increasing the number of context variables.

As illustrated by these examples, the systems and methods described herein may be used to adapt the on-boarding process to business context that characterizes IT scenarios, and formalize the on-boarding process as a common and actionable framework for many different customers. The systems and methods facilitate a shared understanding of the on-boarding process among different people, organizations, and software agents, and allow the service provider to generate flexible process variants based on specific customer environments and parameters. The resulting variant may be further converted into an executable process model used for process tracking and monitoring. Only affected rules need to be modified when a policy changes, and the process template can remain the same. Accordingly, managing rules is much easier than maintaining many variation points. In addition, the approach facilitates search and management of process variants in a large repository. That is, because each variant has contextual metadata, a small set of desired variants can be retrieved using context variables based on the user query.

Accordingly, the approach expedites the on-boarding process and reduces many of the costs commonly associated with IT outsourcing. While initial setup costs may be higher in some circumstances, the incremental cost of adding new process variants diminishes rapidly as the adaptation rules cover an increasing number of scenarios.

Before continuing, it should be noted that the examples described above are provided for purposes of illustration, and are not intended to be limiting. Other devices and/or device configurations may be utilized to carry out the operations described herein.

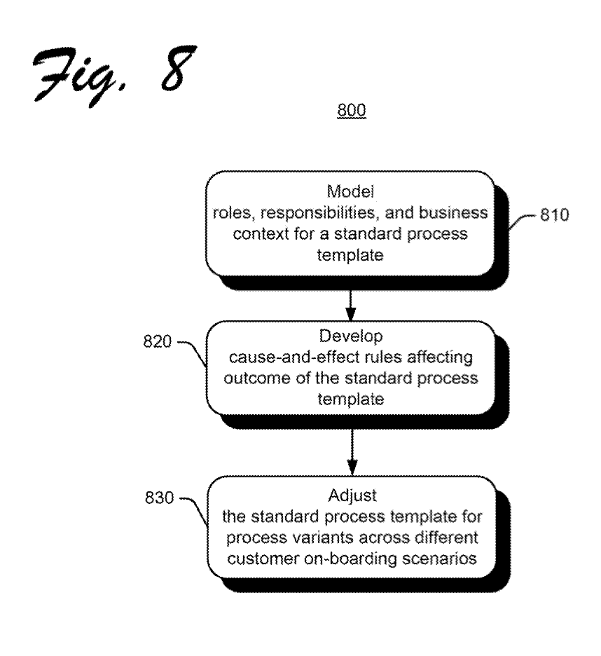

FIG. 8 is a flowchart illustrating example operations which may be implemented for configuring process variants for on-boarding IT outsourcing. Operations 800 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

Operation 810 includes modeling roles, responsibilities, and business context for a standard process template. Operation 820 includes developing cause-and-effect rules affecting outcome of the standard process template. Operation 830 includes adjusting the standard process template for process variants across different customer on-boarding scenarios.

The operations shown and described herein are provided to illustrate example implementations. It is noted that the operations are not limited to the ordering shown. Still other operations may also be implemented.

Still further operations may include separating business policies, process adaptation policies, and workflow adaptation strategies during modeling. Operations may also include only updating the rules when business policies change and/or only updating the rules when IT operations based on business parameters change.

Operations may also include capturing industry vertical, geography, size of outsourcing deal, and contract elements influencing on-boarding for developing the rules, and tailoring a process variant to customer needs. Tailoring may include capturing contextual data as instances in a knowledge base. The contextual data may trigger changes to be applied on the standard process template through the rules.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method of configuring process variants for on-boarding customers for information technology (IT) outsourcing, comprising:
modeling roles, responsibilities, and business context for a standard process template;
developing cause-and-effect rules affecting outcome of the standard process template; and
adjusting the standard process template for process variants across different customer on-boarding scenarios.

2. The method of claim 1, further comprising separating business policies, process adaptation policies, and workflow adaptation strategies during modeling.

3. The method of claim 1, further comprising only updating the rules when business policies change.

4. The method of claim 1, further comprising only updating the rules when IT operations based on business parameters change.

5. The method of claim 1, further comprising capturing business context elements influencing on-boarding for developing the rules.

6. The method of claim 1, further comprising tailoring a process variant to customer needs.

7. The method of claim 6, wherein tailoring comprises capturing contextual data as instances in a knowledge base.

8. The method of claim 6, wherein the contextual data triggers changes to be applied on the standard process template through the rules.

9. A system to configure process variants for on-boarding customers for information technology (IT) outsourcing, comprising:
a standard process template based on roles, responsibilities, and business context;
a plurality of rules affecting outcome of the standard process template; and
a processing environment configured to adjust the standard process template based at least in part on the plurality of rules, and generate output to handle process variants across different customer on-boarding scenarios.

10. The system of claim 9, further comprising semantic rules addressing semantic spaces and the intersection of the semantic spaces.

11. The system of claim 10, wherein triggering the semantic rules add inferred information to a captured business context.

12. The system of claim 11, wherein adding inferred information triggers other rules based on forward chaining.

13. The system of claim 10, wherein the semantic rules include business rules, variant configuration rules, and workflow adaptation rules.

14. The system of claim 13, wherein business rules formalize business policies and address a business context semantic space for customer on-boarding.

15. The system of claim 13, wherein variant configuration rules are triggered by a business context space, produce change operations, and apply the change operations on a standard process template from an on-boarding process semantic space.

16. The system of claim 15, wherein the variant configuration rules address intersection of the business context space and the on-boarding process semantic space.

17. The system of claim 13, wherein the workflow adaptation rules self-adapt a workflow model and address on-boarding process semantic space.

18. A system for configuring process variants for on-boarding customers for information technology (IT) outsourcing, comprising program code stored on a computer readable media and executable by a processor to:
generate a standard process template model based on roles, responsibilities, and business context;
develop rules affecting outcome of the standard process template; and
adjust the standard process template for process variants across different customer on-boarding scenarios.

19. The system of claim 18, wherein the rules are semantic rules addressing semantic spaces and the intersection of the semantic spaces.

20. The system of claim 18, wherein the semantic rules are triggered to add inferred information to a captured business context.
